(19) United States
(12) Patent Application Publication
(10) Pub. No.: US 2003/0129948 A1
(43) Pub. Date: Jul. 10, 2003

(54) System and method for simultaneously testing multiple cordless telephones

(75) Inventors: Berthod Gab, Austin, TX (US); Elie Jreij, Pflugerville, TX (US); Sheng Guan, Austin, TX (US); Hai H. Nguyen, Cedar Park, TX (US)

Correspondence Address: Elsa Keller, Siemens Corporation, Intellectual Property Department, 170 Wood Avenue South, Iselin, NJ, 08830, US

(73) Assignee: Siemens Information and Communication Mobile LLC.

(21) Appl. No.: 10/368,080

(22) Filed: Feb. 18, 2003

Related U.S. Application Data
(63) Continuation of application No. 09/443,999, filed on Nov. 19, 1999.

(51) Int. Cl. H04Q 7/20; H04B 17/00

(52) U.S. Cl. 455/67.1; 455/462

(57) ABSTRACT

A method for testing a plurality of cordless telephones (12,14) includes assigning a temporary ID to each of the plurality of cordless telephones (12,14). Each temporary ID identifies a first activation frequency for each corresponding cordless telephone (12,14). The method also includes activating each cordless telephone (12,14) at the first activation frequency identified by the corresponding temporary ID and simultaneously testing each cordless telephone (12,14) at the corresponding first activation frequency. The method further includes assigning a permanent ID to each cordless telephone (12,14) after completion of the testing. The permanent ID identifies a second activation frequency for a subsequent activation of the cordless telephones (12,14).

### TECHNICAL FIELD OF THE INVENTION

This invention relates generally to the field of telephone systems and, more particularly, to a system and method for simultaneously testing multiple cordless telephones.

### RELATED APPLICATIONS

This application is related to the following copending Applications all filed on Nov. 19, 1999:

Ser. No. ______, entitled System and Method for Wireless Communication Incorporating Error Concealment;

Ser. No. ______, entitled System and Method for Testing An Assembled Telephone;

Ser. No. ______, entitled System and Method for Wireless Communication Incorporating Range Warning;

Ser. No. ______, entitled Method and System for Wireless Telecommunication Between A Mobile Unit and A Base Unit;

Ser. No. ______, entitled Method and System for Avoiding Periodic Bursts of Interference In Wireless Communication Between A Mobile Unit and A Base Unit;

Ser. No. ______, entitled Method and System for Power-Conserving Interference Avoidance in Communication Between A Mobile Unit and A Base Unit In A Wireless Telecommunication System;

Ser. No. ______, entitled Method and System for Changing States In A Wireless Telecommunication System;

Ser. No. ______, entitled Method and System for Wireless Communication Incorporating Distinct System Identifier Bytes to Preserve Multi-frame Synchronization for Systems with Limited Control Channel Bandwidth;

Ser. No. ______, entitled System and Method for Wireless Communication Incorporating Synchronization Concept for 2.4 Ghz Direct Sequence Spread Spectrum Cordless Telephone System;

Ser. No. ______, entitled System And Method For Wireless Communication Incorporating Overloading Prevention Techniques for Multi-frame-synchronized Systems;

Ser. No. ______, entitled System and Method for Wireless Communication Incorporating Preloaded Response Message;

Ser. No. ______, entitled Method and System for a Wireless Communication System Incorporating Channel Selection Algorithm for 2.4 Ghz Direct Sequence Spread Spectrum Cordless Telephone System;

Ser. No. ______, entitled Method and System forks Transmitting and Receiving Caller Id Data in a Wireless Telephone System;

Ser. No. ______, entitled Method and System for Prioritization of Control Messages In A Wireless Telephone System;

Ser. No. ______, entitled Method and System for Wireless Telecommunications Using a Multiframe Control Message;

Ser. No. ______, entitled Method and System for Transmitting Caller Id Information from a Base Station to a Mobile Unit Outside the Context of an Incoming Call; and

Ser. No. ______, entitled Method and System for Data Compression.

### BACKGROUND OF THE INVENTION

Telephone systems are generally mass-produced to provide an efficient and cost-effective method for manufacturing the telephone systems. For example, two or more manufacturing lines may be used to produce one or more different telephone systems such that the telephone systems are assembled efficiently and cost-effectively. Additionally, the manufacturing lines may be located in close proximity to each other such that various components used to produce the telephone systems may be delivered to central locations near the manufacturing lines. Thus, a relatively large volume of telephone systems may be produced in relatively short periods of time.

Telephone system manufacturing operations also generally require testing the telephone systems at one or more stages of the manufacturing process to verify various operating requirements of the telephone system and ensure consumer satisfaction. For example, the telephone system may be tested to verify proper activation, proper operation of a keypad, illumination of a liquid crystal display, and other suitable testing operations to verify various operating parameters of the telephone system.

However, the quantity of telephone systems that may be tested simultaneously is generally limited by the type of telephone system and the proximity of the telephone system to other telephone systems. For example, in cordless telephone systems or other wireless telecommunication systems, interference between the telephone systems may generally impede testing the telephone system. Generally, cordless telephone systems communicate data between a base unit and a mobile unit at one or more frequencies. Thus, one cordless telephone system may be operating at a frequency at or near the operating frequency of another nearby cordless telephone system. Thus, the data communication between the base units and the mobile units of various cordless telephone systems may interfere with each other, thereby increasing the testing time as the cordless telephone, systems attempt to recover from data transmission errors caused by the interference and change frequencies in response to the interference.

### SUMMARY OF THE INVENTION

Accordingly, a need has arisen for a system and method for simultaneously testing multiple cordless telephones that provides greater flexibility and reliability. The present invention provides a system and method for simultaneously testing multiple cordless telephones that addresses shortcomings of prior systems and methods.

According to one embodiment of the present invention, a method for testing a plurality of cordless telephones includes assigning a temporary ID to each of the plurality of cordless telephones. Each temporary ID identifies a first activation frequency for each corresponding cordless telephone. The method also includes activating each cordless telephone at the first activation frequency identified by the corresponding temporary ID and simultaneously testing each cordless telephone at the corresponding first activation frequency. The method further includes assigning a permanent ID to each cordless telephone after completion of the testing. The permanent ID identifies a second activation frequency for a subsequent activation of the cordless telephones.

According to another embodiment of the present invention, a system for testing cordless telephones includes a first cordless telephone and a second cordless telephone. The system further includes a controller coupled to the first and second cordless telephones and operable to transmit a first frequency signal to the first cordless telephone and a second frequency signal to the second cordless telephone. The first frequency signal is operable to identify a first activation frequency for the first cordless telephone. The second frequency signal is operable to identify a second activation frequency for the second cordless telephone and is different than the first activation frequency. The controller is further operable to simultaneously test the first and second cordless telephones operating at the corresponding first and second activation frequencies, respectively.

The present invention provides several technical advantages. For example, according to one aspect of the present invention, a frequency signal is transmitted to each cordless telephone such that each cordless telephone is operating at a different frequency. The frequency signal transmitted to each cordless telephone may also be used to direct the tested cordless telephone to maintain operation at the frequency identified by the frequency signal. Thus, each cordless telephone activates and continues to operate a particular frequency designated by the frequency signal, thereby substantially eliminating interference between the cordless telephones wile being simultaneously operated and tested. Additionally, maintaining operation of the cordless telephones at the frequencies designated by the frequency signals substantially prevents interference from attempts of the cordless telephones to change frequencies.

According to another aspect of the present invention, a temporary ID is assigned to each cordless telephone during assembly of the cordless telephones. The temporary ID may be used to designate a testing activation frequency for the cordless telephones. For example, the temporary ID may be used to designate an initial activation frequency to be used by the cordless telephone upon the initial activation of the cordless telephone. The temporary ID may be controlled and selected such that multiple cordless telephones may be operated and tested simultaneously. Once testing is complete, a permanent ID may be assigned to each cordless telephone designating an activation frequency for a subsequent activation of each cordless telephone. Thus, interference between the cordless telephones during testing of the cordless telephones is substantially eliminated.

Other technical advantages will be readily apparent to one skilled in the art from the following figures, descriptions, and claims.

### BRIEF DESCRIPTION OF THE DRAWINGS

For a more complete understanding of the present invention and the advantages thereof, reference is now made to the following descriptions taken in connection with the accompanying drawings, in which:

FIG. 1 is a diagram illustrating a system for simultaneously testing multiple cordless telephones in accordance with an embodiment of the present invention;

FIG. 2 is a flow diagram illustrating a method for simultaneously testing multiple cordless telephones in accordance with an embodiment of the present invention;

FIG. 3 is a flow diagram illustrating another method for simultaneously testing multiple cordless telephones in accordance with an embodiment of the present invention; and

FIG. 4 is a flow diagram illustrating another method for simultaneously testing multiple cordless telephones in accordance with an embodiment of the present invention.

### DETAILED DESCRIPTION OF THE INVENTION

Embodiments of the present invention and the advantages thereof are best understood by referring to the following description and drawings, wherein like numerals are used for like and corresponding parts of the various drawings.

FIG. 1 is a diagram illustrating a system 10 for simultaneously testing multiple cordless telephones in accordance with an embodiment of the present invention. In the embodiment illustrated in FIG. 1, three cordless telephones 12, 14, and 16 are being tested using system 10. However, a greater or fewer quantity of cordless telephones may also be tested using system 10. Each cordless telephone 12, 14, and 16 generally comprises a base unit 18 and a mobile unit 20. Each base unit 18 and mobile unit 20 also generally includes an antenna 22 and 24, respectively, for transmitting data or communication signals between base units 18 and mobile units 20.

Generally, each cordless telephone 12, 14, and 16 is assigned a permanent identifier or ID designating a particular activation frequency to be used by cordless telephones 12, 14, and 16 upon initial activation of cordless telephones 12, 14, 16. The permanent ID assigned to each cordless telephone 12, 14, and 16 may also be used to identify corresponding base units 18 and mobile units 20 for data communication. For example, the permanent ID may be used to ensure that a mobile unit 20 of cordless telephone 12 communicates only with a base unit 18 of cordless telephone 12, thereby substantially limiting the number of occurrences where a mobile unit from one cordless telephone may communicate with a base unit of another cordless telephone. The permanent ID may generally be assigned during the manufacturing process and stored in EEPROM of cordless telephones 12, 14, and 16.

In the embodiment illustrated in FIG. 1, system 10 includes a controller 30 coupled to each cordless telephone 12, 14, and 16 for controlling various testing operations of cordless telephones 12, 14, and 16. Controller 30 may comprise a computer, mini-computer, workstation, mainframe, or other computing device using a processor 32 and a memory 34 that may be used for testing cordless telephones 12, 14, and 16. Memory 34 may include computer software or program files that may be executed by processor 32. A computer software may generally be identified by modules, engines and similar systems in memory 34. It will be understood that the computer software may be otherwise combined and/or divided for processing within the scope of the present invention. Accordingly, labels of the modules and other software systems are for illustrative purposes and may be varied and still remain within the scope of the present invention.

Memory 34 may include a frequency module 36, and an ID module 38. Frequency module 36 may be used to determine and designate a particular activation frequency for each cordless telephone 12, 14, and 16. ID module 38 may be used to determine and designate a particular ID for each cordless telephone 12, 14, and 16. For example, in the embodiment illustrated in FIG. 1, each cordless telephone 12, 14, and 16 may be assigned a permanent ID during the manufacturing process of producing cordless telephones 12, 14, and 16, each permanent ID identifying activation frequencies to be used by cordless telephones 12, 14, and 16 upon initial activation. The frequency associated with the permanent ID may be determined using frequency module 36, and the permanent ID may be determined using ID module 38. Controller 30 may then be used to transmit the permanent ID to each cordless telephone 12, 14, and 16. However, the permanent ID may also be assigned to each cordless telephone 12, 14, and 16 at other various stages of the manufacturing process. Additionally, other suitable methods and systems may be used for determining the frequency and corresponding ID assigned to each cordless telephone 12, 14, and 16.

In operation, controller 30 may be used to transmit a frequency signal to each cordless telephone 12, 14, and 16 to identify a particular activation frequency to be used during testing operations. For example, frequency module 36 may be used to determine the activation frequencies to be assigned to each cordless telephone 12, 14, and 16 for testing operations. Additionally, frequency module 36 may be used to record and monitor the activation frequencies assigned to cordless telephones 12, 14, and 16 such that minimal repeated use of the activation frequencies occurs. Thus, the frequency signal transmitted to each cordless telephone 12, 14, and 16 may be used to generally override the activation frequency identified by each corresponding permanent ID assigned to cordless telephones 12, 14, and 16. Alternatively, controller 30 may be used to assign a permanent ID to each cordless telephone 12, 14, and 16 upon completion of testing operations.

Thus, controller 30 transmits a frequency signal to each cordless telephone 12, 14, and 16 specifying a particular activation frequency to be used upon activation of each cordless telephone 12, 14, and 16. The activation frequencies determined and transmitted to cordless telephones 12, 14, and 16 may be substantially different, thereby substantially eliminating frequency interference during operation of cordless telephones 12, 14, and 16 during the testing operation.

Additionally, the frequency signal may direct each cordless telephone 12, 14, and 16 to maintain operation at the corresponding activation frequency directed by each corresponding frequency signal for the duration of the testing operation. However, controller 30 may also transmit an additional signal to each cordless telephone 12, 14, and 16 directing each cordless telephone 12, 14, and 16 to maintain operation at the corresponding activation frequencies. Thus, the time required for testing operations may be substantially decreased by substantially preventing the changing of frequencies by each cordless telephone 12, 14, and 16.

Referring to FIG. 1, according to another embodiment of the present invention, controller 30 may be used to transmit and store in each cordless telephone 12, 14 and 16 a temporary ID identifying a particular activation frequency to be used by each cordless telephone 12, 14, and 16 upon initial activation. The temporary ID may be determined using frequency module 36 and ID module 38. However, other suitable methods or systems may also be used to determine the temporary ID assigned to each cordless telephone 12, 14, and 16. Additionally, the temporary ID may be assigned to each cordless telephone 12, 14, and 16 at other various stages of the manufacturing process.

Thus, in operation, controller 30 may be used to activate each cordless telephone 12, 14, and 16 to initiate a testing program. Because the temporary ID assigned to each cordless telephone 12, 14, and 16 designates a different activation frequency, interference between cordless telephones 12, 14, and 16 is substantially eliminated during the testing operations.

Therefore, system 10 may be used to simultaneously test cordless telephones 12, 14, and 16 while substantially eliminating interference between cordless telephones 12, 14 and 16, thereby decreasing the time required to test cordless telephones 12, 14, and 16.

As described above controller 30 may also be used to maintain operation of cordless telephones 12, 14, and 16 at the activation frequencies identified by the temporary ID assigned to each cordless telephone. 12, 14, and 16.

For example, the temporary ID assigned to each cordless telephone 12, 14, and 16 may direct each cordless telephone 12, 14, and 16 to maintain operating at the designated activation frequency. However, controller 30 may also transmit an additional signal to each cordless telephone 12, 14, and 16 directing each cordless telephone 12, 14, and 16 to maintain operations at the activation frequencies identified by each corresponding temporary ID.

Alternatively, each cordless telephone 12, 14, and 16 may be configured to change frequencies from the activation frequency identified by each corresponding temporary ID as required to recover from interference. For example, after initial activation of each cordless telephone 12, 14, and 16, at the activation of frequencies identified by each corresponding temporary ID, each cordless telephone 12, 14, and 16 may be configured to change frequencies in response to data transmission errors resulting from other external interference sources. Thus, system 10 may be used to control the initial activation frequencies of cordless telephones 12, 14, and 16 to substantially prevent interference between cordless telephones 12, 14, and 16 upon initial activation for testing operations.

After various testing operations are complete, controller 30 may be used to assign a permanent ID to each cordless telephone 12, 14, and 16 identifying an activation frequency for a subsequent activation of each cordless telephone 12, 14, and 16. For example, frequency module 36 and ID module 38 may be used to determine the frequency and corresponding permanent ID assigned to each cordless telephone 12, 14, and 16. However, the permanent ID may also be assigned to each cordless telephone 12, 14, and 16 at other various stages of the manufacturing process.

According to another embodiment of the present invention, both a temporary ID and a permanent ID may be assigned to each cordless telephone 12, 14, and 16. In operation, controller 30 may be used to transmit a control signal to each cordless telephone 12, 14, and 16 directing each cordless telephone 12, 14, and 16 to use an activation frequency identified by the assigned temporary ID for testing operations. Each cordless telephone 12, 14, and 16 may be configured such that the assigned permanent ID may be used to identify the activation frequency absent a control signal from controller 30 or other device directing cordless telephone 12, 14, and 16 to use the activation frequency identified by the temporary ID. Therefore, the present invention provides greater flexibility than prior systems and methods by providing a variety of techniques for simultaneously testing cordless telephones while substantially eliminating interference between the cordless telephones.

Referring to FIG. 1, according to another embodiment of the present invention, system 10 may also comprise a ring tone detector 40. Ring tone detector 40 may be used to detect a ring tone from each cordless telephone 12, 14, and 16 to verify proper operation of each cordless telephone 12, 14, and 16. Each cordless telephone 12, 14, and 16 may be configured having multiple available ring tones for notifying a user of cordless telephone 12, 14, and 16 of an incoming call or other type of message associated with cordless telephones 12, 14, and 16.

Controller 30 may be used to transmit a ring signal to each cordless telephone 12, 14, and 16 directing each cordless telephone 12, 14, and 16 to ring. The ring signal may direct each cordless telephone 12, 14, and 16 to use a different ring tone. However, other suitable methods or systems may also be used to control the ring tones used by cordless telephones 12, 14, and 16. For example, cordless telephones 12, 14, and 16 may be assigned or configured to use a particular ring tone at a stage of the manufacturing process such that a limited number of available ring tones may be sequentially used to minimize repeated use of the ring tones by cordless telephones in close proximity to each other.

Controller 30 may then be used to activate a ring of each cordless telephone 12, 14, and 16 to simulate an incoming call to verify proper operation of each cordless telephone 12, 14, and 16. Ring tone detector 40 may be used to detect and identify the ring tones emitted by each cordless telephone 12, 14, and 16. Ring tone detector 40 may then transmit to controller 30 data corresponding to the ring tones detected and identified. Controller 30 may then be used to identify and determine proper operation of cordless telephones 12, 14, and 16.

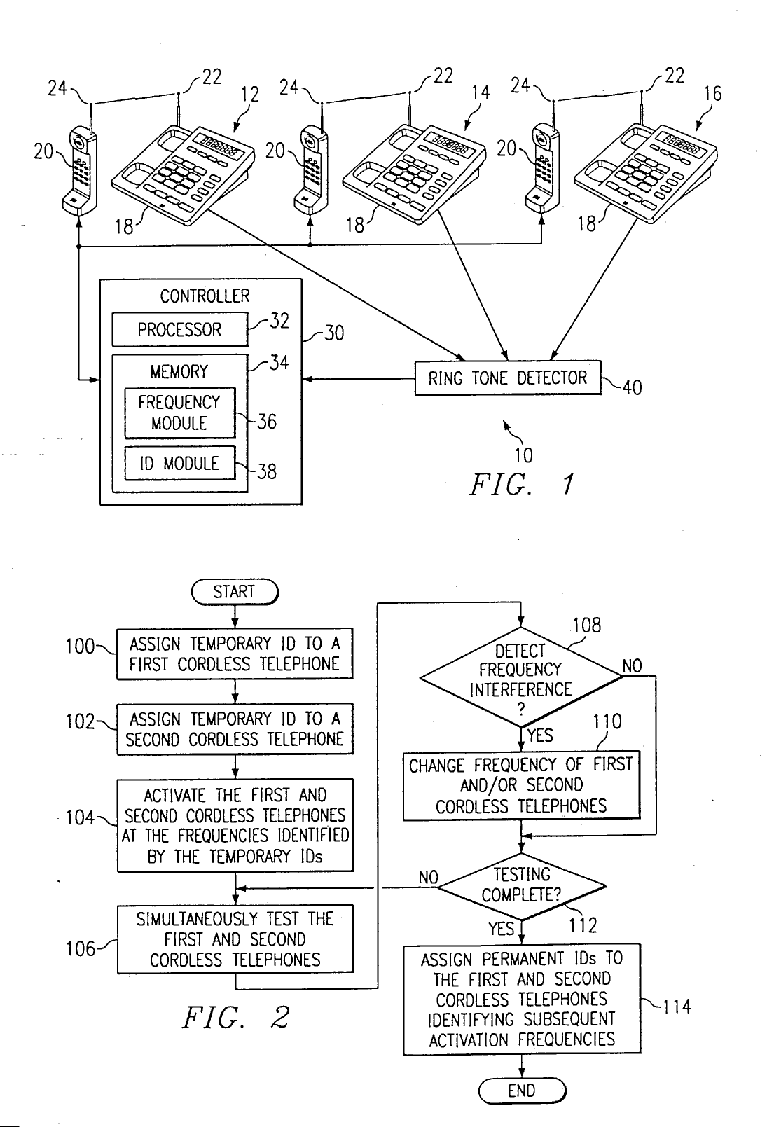

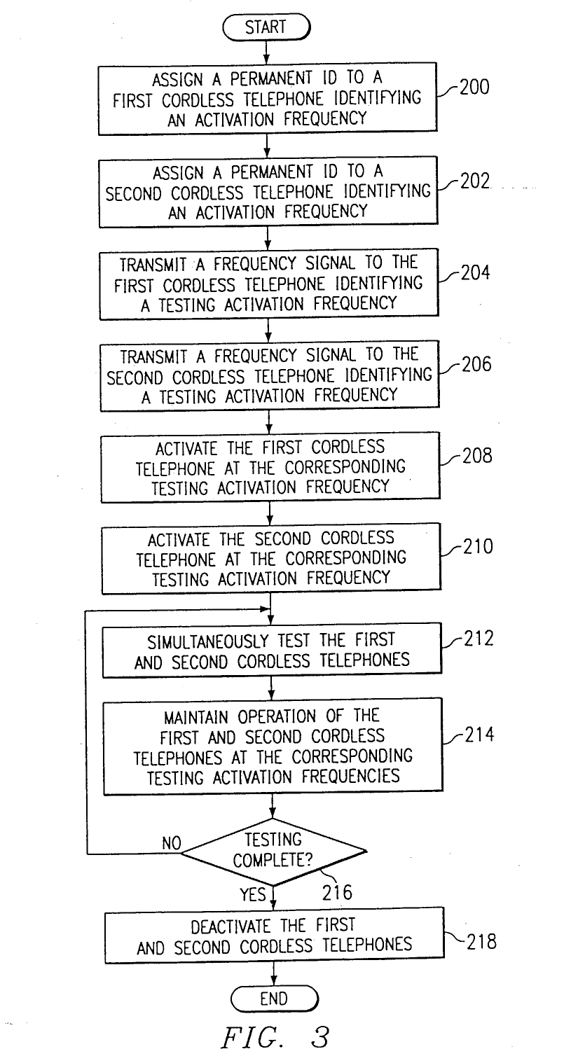

FIG. 2 is a flow diagram illustrating a method for simultaneously testing multiple cordless telephones in accordance with an embodiment of the present invention. The method begins at step 100 where a temporary ID is assigned to cordless telephone 12. A temporary ID is also assigned to cordless telephone 14 at step 102. As described above, the temporary ID assigned to cordless telephones 12 and 14 identify an activation frequency to be used by cordless telephones 12 and 14 upon activation.

At step 104, cordless telephones 12 and 14 are activated and operated at the activation frequencies identified by each corresponding temporary ID. At step 106, controller 30 may be used to simultaneously test cordless telephones 12 and 14. At decisional step 108, each cordless telephone 12 and 14 determines whether interference is detected from another cordless telephone or from other external sources. If interference is not detected, the method proceeds directly to step 112. If interference is detected, the method proceed to step 110 where each cordless telephone 12 and 14 may change operating frequencies to avoid the interference.

At decisional step 112, a determination is made whether testing operations are complete. If additional testing is required, the method returns to step 106. If testing operations are complete, the method proceeds to step 114. At step 114, a permanent ID may be assigned to each cordless telephone 12 and 14 identifying an activation frequency to be used by each cordless telephone 12 and 14 for a subsequent activation. As described above, controller 30 may be used to assign the permanent ID to cordless telephones 12 and 14. However, the permanent ID may be otherwise determined and assigned to cordless telephones 12 and 14.

FIG. 3 is a flow diagram illustrating another method for simultaneously testing multiple cordless telephones in accordance with an embodiment of the present invention. The method begins at step 200 where a permanent ID is assigned to cordless telephone 12 identifying an activation frequency to be used upon activation of cordless telephone 12. At step 202, a permanent ID is assigned to cordless telephone 14 identifying an activation frequency to be used by cordless telephone 14 upon activation of cordless telephone 14.

At step 204, controller 30 is used to transmit a frequency signal to cordless telephone 12 identifying an activation frequency to be used during testing operations. At step 206, controller 30 is used to transmit a frequency signal to cordless telephone 14 identifying an activation frequency to be used by cordless telephone 14 during testing operations. The frequency signals transmitted to cordless telephones 12 and 14 may be selected and controlled such that interference between cordless telephones 12 and 14 is substantially eliminated during testing operations.

At step 208, controller 30 may be used to activate cordless telephone 12 at the activation frequency corresponding to the frequency signal transmitted to cordless telephone 12. At step 210, controller 30 may be used to activate cordless telephone 14 at the activation frequency corresponding to the frequency signal transmitted to cordless telephone 14. At step 212, controller 30 may be used to simultaneously test cordless telephones 12 and 14.

At step 214, controller 30 may be used to maintain operation of cordless telephones 12 and 14 at the activation frequencies identified by corresponding frequency signals transmitted to each cordless telephone 12 and 14. For example, the frequency signal transmitted to each cordless telephone 12 and 14 may direct each cordless telephone 12 and 14 to maintain operations at the designated activation frequency. However, another signal may be transmitted by controller 30 to each cordless telephone 12 and 14 directing each cordless telephone 12 and 14 to maintain operations at the designated activation frequencies. Other suitable methods and devices may also be used to maintain operation of cordless telephones 12 and 14 at the designated activation frequencies corresponding to the frequency signals.

At decisional step 216, a determination is made whether additional testing is required. If additional testing is required, the method returns to step 212. If additional testing is not required, the method proceeds to step 218. At step 218, controller 30 may be used to deactivate cordless telephones 12 and 14. Thus, in operation, the permanent ID assigned to cordless telephones 12 and 14 is used to control a subsequent activation frequency for cordless telephones 12 and 14 following the testing operations and the frequency signal transmitted to cordless telephones 12 and 14 may be used to override the frequencies identified by the permanent ID during testing operations.

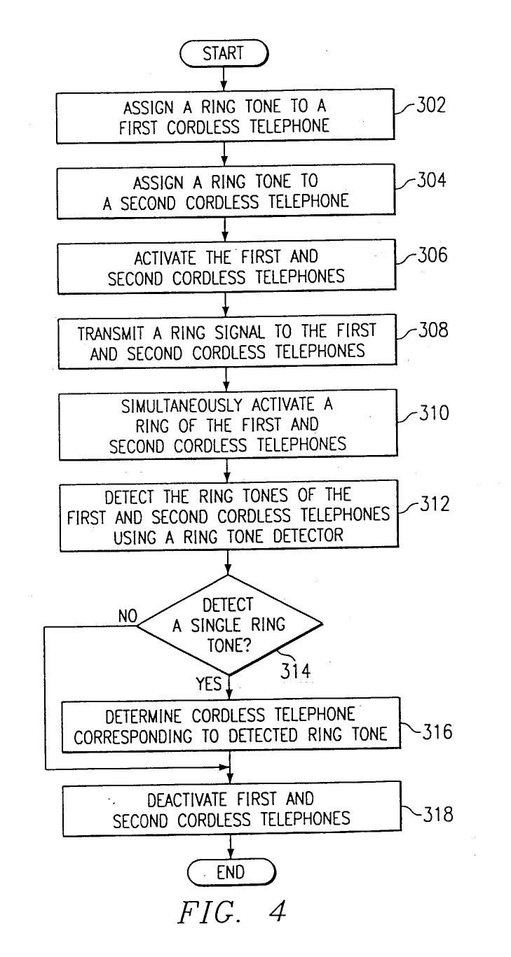

FIG. 4 is a flow diagram illustrating another method for simultaneously testing multiple cordless telephones in accordance with an embodiment of the present invention. The method begins at step 302 where a particular ring tone is assigned to or selected for cordless telephone 12. At step 304, a particular ring tone is assigned to or selected for cordless telephone 14. The ring tones are selected for cordless telephones 12 and 14 such that ring tone detector 40 may be used to detect and identify various ring tones emitted simultaneously by cordless telephones 12 and 14. As described above, the ring tones assigned or selected for cordless telephones 12 and 14 may be performed using controller 30 or may be performed at other various stages of the manufacturing process.

At step 306, controller 30 may be used to activate cordless telephones 12 and 14. At step 308, controller 30 may transmit a ring signal to cordless telephones 12 and 14 directing cordless telephones 12 and 14 to ring using the corresponding selected ring tones. At step 310, controller 30 may simultaneously activate a simultaneous ring of cordless telephones 12 and 14 corresponding to the ring signals transmitted to cordless telephones 12 and 14.

At step 312, ring tone detector 40 may be used to detect and identify the ring tones emitted by cordless telephones 12 and 14. As described above, ring tone detector 40 may transmit data to controller 30 corresponding to the detected and identified ring tones such that controller 30 may be used to verify proper operation of cordless telephones 12 and 14. At decisional step 314, a determination may be made whether all ring tones directed by controller 30 were detected by ring tone detector 40. If all ring tones were detected by ring tone detector 40, the method proceeds to step 318. If all ring tones were not detected by ring tone detector 40, the method proceeds to step 316.

As described above, controller 30 may be used to identify which cordless telephone 12 or 14 emitted the detected ring tone using data received from ring tone detector 40. Thus, controller 30 may be used to verify proper operation of cordless telephones 12 and 14. At step 318, controller 30 may be used to deactivate cordless telephones 12 and 14.

Therefore, the present invention provides greater flexibility and reliability than prior testing systems and methods by providing simultaneous testing of cordless telephones while substantially preventing interference between the cordless telephones. Additionally, the present invention provide a variety of different testing techniques to substantially reduce or eliminate interference between simultaneously tested cordless telephones.

Although the present invention and its advantages have been described in detail, it should be understood that various changes, substitutions, and alterations can be made therein without departing from the spirit and scope of the present invention as defined by the appended claims.

What is claimed is:

1. A method for testing a plurality of cordless telephones, comprising:
assigning a temporary ID to each of the plurality of cordless telephones, each temporary ID identifying a first activation frequency for each corresponding cordless telephone;
activating each cordless telephone at the first activation frequency identified by the corresponding temporary ID;
simultaneously testing each cordless telephone at the corresponding first activation frequency; and
assigning a permanent ID to each cordless telephone after completion of the testing, the permanent ID identifying a second activation frequency for a subsequent activation of the cordless telephones.

2. The method of claim 1, further comprising:
determining an interference level associated with the first activation frequency;
determining whether the determined interference level exceeds a predetermined level; and
changing the first activation frequency to a third frequency, the third frequency different than the first activation frequency.

3. The method of claim 2, further comprising testing the cordless telephone at the third frequency.

4. The method of claim 1, further comprising:
detecting transmission errors during the testing of the cordless telephones;
determining whether a level of the transmission errors exceeds a predetermined level; and
changing the first activation frequency to a third frequency, the third frequency different than the first activation frequency.

5. The method of claim 4, further comprising testing the cordless telephone at the third frequency.

6. The method of claim 1, further comprising operating each of the cordless telephones at the corresponding first activation frequency for the duration of the testing.

7. A system for testing cordless telephones, comprising:
a first cordless telephone;
a second cordless telephone; and
a controller coupled to the first and second cordless telephones and operable to transmit a first frequency signal to the first cordless telephone and a second frequency signal to the second cordless telephone, the first frequency signal operable to identify a first activation frequency for the first cordless telephone, the second frequency signal operable to identify a second activation frequency for the second cordless telephone, the first activation frequency different than the second activation frequency, and wherein the controller is further operable to simultaneously test the first and second cordless telephones at the corresponding first and second activation frequencies, respectively.

8. The system of claim 7, wherein the controller is further operable to maintain the first cordless telephone operating at the first activation frequency for the duration of the testing.

9. The system of claim 8, wherein the controller is further operable to maintain the second cordless telephone operating at the second activation frequency for the duration of the testing.

10. The system of claim 7, wherein the first cordless telephone comprises an ID identifying a third activation frequency for a subsequent activation of the first cordless telephone.

11. The system of claim 10, wherein the second cordless telephone comprises an ID identifying a fourth activation frequency for a subsequent activation of the second cordless telephone.

12. The system of claim 7, wherein the controller is further operable to change the first activation frequency of the first cordless telephone to a third frequency during testing of the first cordless telephone.

13. A method for testing a plurality of cordless telephones, comprising:
transmitting a first frequency signal to a first cordless telephone identifying a first activation frequency for the first cordless telephone;
transmitting a second frequency signal to a second cordless telephone identifying a second activation frequency for the second cordless telephone, the first activation frequency different than the second activation frequency;
activating the first and second cordless telephones at the first and second activation frequencies, respectively; and
simultaneously testing the first and second cordless telephones.

14. The method of claim 13, further comprising assigning the first cordless telephone a permanent ID identifying a third activation frequency for a subsequent activation of the first cordless telephone.

15. The method of claim 14, further comprising assigning the second cordless telephone a permanent ID identifying a fourth activation frequency for a subsequent activation of the second cordless telephone.

16. The method of claim 13, wherein the first frequency signal is further operable to maintain operation of the first cordless telephone at the first activation frequency for the duration of the testing.

17. The method of claim 13, wherein the second frequency signal is further operable to maintain operation of the second cordless telephone at the second activation frequency for the duration of the testing.

18. The method of claim 13, further comprising:
transmitting a third frequency signal to a third cordless telephone identifying a third activation frequency for the third cordless telephone, the third activation frequency different than the first and second activation frequencies;
activating the third cordless telephone at the third activation frequency; and
simultaneously testing the third cordless telephone with the first and second cordless telephones.

19. The method of claim 18, wherein the third frequency signal is further operable to maintain operation of the third cordless telephone at the third activation frequency for the duration of the testing.

20. The method of claim 18, further comprising assigning a permanent ID to the third cordless telephone identifying a fourth activation frequency for a subsequent activation of the third cordless telephone.

21. A method for testing a plurality of cordless telephones, comprising:
assigning a first ring tone to a first cordless telephone;
assigning a second ring tone to a second cordless telephone, the first ring tone different than the second ring tone;
activating the first and second cordless telephones;
transmitting a ring signal to the first and second cordless telephones, the ring signal operable to simultaneously activate the first and second ring tones; and
detecting the first and second ring tones using a ring detector.

22. The method of claim 21, further comprising:
assigning a third ring tone to a third cordless telephone, the third ring tone different than the first and second ring tones;
activating the third cordless telephone;
wherein transmitting the ring signal comprises transmitting the ring signal the first, second and third cordless telephones to simultaneously activate the first, second and third ring tones, respectively; and
wherein detecting comprises detecting the first, second and third ring tones using the ring detector.

23. The method of claim 21, wherein transmitting comprises transmitting the ring signal to a mobile unit of each of the first and second cordless telephones.

24. The method of claim 21, further comprising determining whether the first or second cordless telephone rang in response to detecting only the first or second ring tone.
